(19) United States
(12) Patent Application Publication
(10) Pub. No.: US 2023/0133793 A1
(43) Pub. Date: May 4, 2023

(54) FEDERATED LEARNING SYSTEM FOR PERFORMING INDIVIDUAL DATA CUSTOMIZED FEDERATED LEARNING, METHOD FOR FEDERATED LEARNING, AND CLIENT ARATUS FOR PERFORMING SAME

(71) Applicant: Korea Advanced Institute of Science and Technology, Daejeon (KR)

(72) Inventors: Jae Hoon OH, Daejeon (KR); Sang Mook KIM, Daejeon (KR); Se Young YUN, Daejeon (KR); Sang Min BAE, Daejeon (KR); Jae Woo SHIN, Daejeon (KR); Seong Yoon KIM, Daejeon (KR); Woo Jin CHUNG, Daejeon (KR)

(73) Assignee: Korea Advanced Institute of Science and Technology, Daejeon (KR)

(21) Appl. No.: 17/975,664

(22) Filed: Oct. 28, 2022

(30) Foreign Application Priority Data
Nov. 3, 2021 (KR) 10-2021-0149729
Jun. 20, 2022 (KR) 10-2022-0075186

(51) Int. Cl. G06N 20/00

(52) U.S. Cl. CPC G06N 20/00

(57) ABSTRACT

Proposed is a federated learning system. The federated learning system may comprise: a central server configured to transmit a first parameter of an extractor in a federated learning model including the extractor and a classifier to each of a plurality of client devices, and receive a plurality of first parameters learned from the plurality of client devices to update the federated learning model; and the plurality of client devices configured to train each of the plurality of the first parameters of the federated learning model using a training data set stored in each of the plurality of client devices while maintaining a value of a second parameter value of the classifier in the federated learning model, and to transmit each of the plurality of the trained first parameters to the central server.

### CROSS-REFERENCE TO RELATED APPLICATIONS

This application claims the priority of Korean Patent Application No. 10-2021-0149729 filed on Nov. 3, 2021 and Korean Patent Application No. 10-2022-0075186 filed on Jun. 20, 2022, in the Korean Intellectual Property Office, the disclosure of which is incorporated herein by reference.

### TECHNICAL FIELD

The present disclosure relates to a method and an apparatus for performing individual data customized federated learning of a client.

This work was supported by Institute of Information & communications Technology Planning & Evaluation (IITP) grant funded by Korea government (MSIT) [No. 2021-0-00907, Development of Adaptive and Lightweight Edge-Collaborative Analysis Technology for Enabling Proactively Immediate Response and Rapid Learning, 90%] and [No. 2019-0-00075, Artificial Intelligence Graduate School Program (KAIST), 10%].

### BACKGROUND

Recently, with the development of cloud and big data technologies, artificial intelligence (AI) technology is being applied to various services. In order to apply such artificial intelligence technology to services, the procedure of training an artificial intelligence model based on a large amount of data must be preceded.

Training artificial intelligence models requires considerable computer resources to perform large-scale computations. In this regard, the cloud computing service is useable for train artificial intelligence models, which provides a cloud computing infrastructure to train artificial intelligence models without installing complex hardware and software. Because cloud computing is based on centralization of resources, all necessary data should be stored in a cloud memory and utilized for model learning. That is, Data centralization offers many advantages in terms of maximizing efficiency, but there is a risk of leakage of user personal data and significant network costs are incurred as data transfer is involved.

In recent years, federated learning has been actively studied to overcome these problems. Federated learning is a learning method that centrally collects models trained by each client device based on individual data owned by multiple client devices, rather than training by centrally collecting user personal data. Since such federated learning does not centrally collect user personal data, there is little possibility of invasion of privacy, and network costs can be reduced because only the parameters of the updated model can be transmitted.

However, since the data sets of each client device actually used for federated learning are different from each other in number, type, distribution, domain etc., a catastrophic forgetting problem that loses the direction of learning caused by an imbalance in the data used in the federated learning process can arise.

Furthermore, although the model that finally completed the federated learning generally shows high performance, there are cases where it shows insufficient performance when applied to individual client devices using a data set of a specific distribution.

### SUMMARY

Because various problems may be caused due to data imbalance of each client device used for federated learning, the problem to be solved by the present disclosure is, primarily, to update some parameters of the federated learning model by allowing each client device to train the extractor in the federated learning model, and secondarily, to provide a federated learning method and a federated learning apparatus for each client device to individually train the classifier in the federated learning model according to a training data set stored in each client device.

However, the problem to be solved by the present disclosure is not limited as mentioned above, and although not mentioned, it may include a purpose that can be clearly understood by those of ordinary skill in the art to which the present disclosure belongs from the description below.

In accordance with an aspect of the present disclosure, there is provided a federated learning system, the federated learning system may comprise: a central server configured to transmit a first parameter of an extractor in a federated learning model including the extractor and a classifier to each of a plurality of client devices, and receive a plurality of first parameters trained from the plurality of client devices to update the federated learning model; and the plurality of client devices configured to train each of the plurality of the first parameters of the federated learning model using a training data set stored in by each client device while maintaining a value of a second parameter value of the classifier in the federated learning model, and to transmit each of the plurality of the trained first parameters to the central server.

When each of the plurality of client devices receive the federated learning model on which federated learning is completed from the central server, each of the plurality of client devices may update the second parameter of the federated learning model using the training data set.

The second parameter may maintain a preset value according to a predetermined weight initialization algorithm in the training process of each of the plurality of the first parameters of each of the plurality of client devices.

The second parameter may maintain a preset value according to an orthogonal initialization algorithm in the training process of each of the plurality of the first parameters of each of the plurality of client devices.

The classifier may include a layer of the last end in contact with an output layer among layers included in the federated learning model, and the extractor may include at least one of layers from the frontmost layer in contact with an input layer to a layer just before the layer of the last end among the layers included in the federated learning model.

In accordance with another aspect of the present disclosure, there is provided a federated learning method, the federated learning method may comprise: transmitting, by the central server, a first parameter of an extractor in a federated learning model including the extractor and a classifier to each of a plurality of client devices; training, by the plurality of client devices, each of the plurality of the first parameters of the federated learning model by each of the plurality of client devices by using a training data set stored in each client device while maintaining a value of a second parameter of the classifier in the federated learning model, transmitting, by the plurality of client devices, each of the plurality of the trained first parameters to the central server; and updating, by the central server, the federated learning model by receiving the plurality of the first parameters trained from each of the plurality of client devices.

The federated learning method may comprise after the updating of the federated learning model, by each of the plurality of client devices, receiving the federated learning model on which federated learning is completed from the central server, and updating the second parameter of the federated learning model using the training data set.

The transmitting of each of the plurality of the trained first parameters to the central server may comprise controlling a preset value to be maintained in the second parameter according to a predetermined weight initialization algorithm in the training process of each of the plurality of the first parameters.

The transmitting of the learned first parameter to the central server may comprise controlling a preset value to be maintained in the second parameter according to an orthogonal initialization algorithm in the training process of each of the plurality of the first parameters.

The classifier may include a layer of the last end in contact with an output layer among layers included in the federated learning model, and the extractor may include at least one of layers from the frontmost layer in contact with an input layer to a layer just before the layer of the last end among the layers included in the federated learning model.

In accordance with another aspect of the present disclosure, there is provided a client device for training a federated learning model, the client device may comprise: a communication unit that transmits and receives information to and from a central server; a memory; and a processor, wherein the processor is configured to: receive a first parameter of an extractor from the central server that manages a federated learning model including the extractor and a classifier; train the first parameter of the federated learning model using a training data set stored in the client device, while maintaining a value of a second parameter of the classifier in the federated learning model; and transmit the trained first parameter to the central server to update the federated learning model managed by the central server.

According to an embodiment of the present disclosure, after dividing the federated learning model into an extractor and a classifier, by intensively training the extractor in the federated learning model from the data held by each client device in the primary training process of training the global model, it is possible to increase the federated learning speed.

In addition, in the secondary training process of individually training the local model after completing the global model learning, each client device uses the training data set stored in each client device to individually train the classifier, so that each client device owns a federated learning model with a customized decision boundary based on training data set stored in each client device, and thus, each client device may use a model with significantly improved accuracy for the data it mainly uses.

The effects obtainable in the present disclosure are not limited to the above-mentioned effects, and other effects not mentioned above may be clearly understood by those of ordinary skill in the art to which the present disclosure belongs from the description below.

### BRIEF DESCRIPTION OF THE DRAWINGS

FIG. 1 is a block diagram of a federated learning system according to an embodiment of the present disclosure.

FIG. 2 is an exemplary diagram illustrating a structure of a federated learning model used in the federated learning system according to the embodiment of the present disclosure.

FIG. 3 is an exemplary diagram illustrating an operation in which a central server transmits a first parameter to each client device and each client device learns the first parameter according to the embodiment of the present disclosure.

FIG. 4 is an exemplary diagram illustrating an operation of transmitting the first parameter updated by each client device to the central server, and updating by the central server the first parameter of the federated learning model by collecting each first parameter according to the embodiment of the present disclosure.

FIG. 5 is an exemplary diagram illustrating an operation of transmitting, by the central server, a federated learning model on which learning is completed to each client device, and learning, by each client device, a second parameter of the federated learning model according to the embodiment of the present disclosure.

FIG. 6 is an exemplary diagram illustrating a state of a second parameter that is individualized according to a data set owned by each client device according to the embodiment of the present disclosure.

FIG. 7 is a flowchart of a federated learning method according to the embodiment of the present disclosure.

FIG. 8 is a comparison table of accuracies measured by applying the same dataset to a federated learning model (FedBABU) generated by a federated learning system according to the embodiment of the present disclosure and to a federated learning model generated by an existing federated learning algorithm in a plurality of client devices.

### DETAILED DESCRIPTION OF THE EMBODIMENTS

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

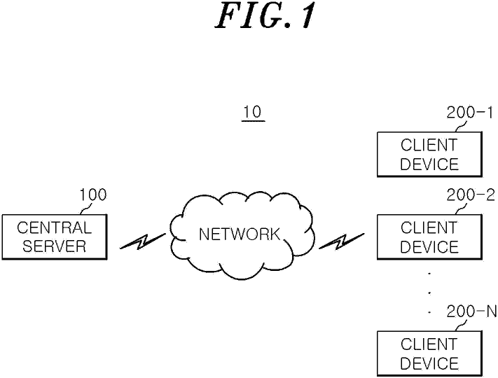

FIG. 1 is a block diagram of a federated learning system 10 according to an embodiment of the present disclosure.

Referring to FIG. 1, the federated learning system 10 according to the embodiment may include a central server 100 and a plurality of client devices 200.

The central server 100 and the client device 200 are computing devices including a memory and a processor, and overall operations may be performed by instructions stored in the memory and operations of the processor.

The central server 100 and the client device 200 may store an artificial intelligence neural network model designed with the same structure to perform federated learning.

Hereinafter, an artificial intelligence neural network model used for federated learning according to the embodiment of this document will be referred to as a ‘federated learning model’. In addition, if it is necessary to classify the device in which the ‘federated learning model’ is stored, the federated learning model stored in the central server 100 will be referred to as a ‘global model’, and the federated learning model stored in the client device 200 will be referred to as a ‘local model’.

The general operation for the central server 100 and the client device 200 constituting the federated learning system 10 to train the federated learning model is as follows.

First, the central server 100 may transmit parameter values set in the global model to each client device 200.

Next, each client device 200 may train a local model using its own data, and may transmit parameters of the trained local model to the central server 100.

Thereafter, the central server 100 may update the parameters of the global model by collecting the parameters of the local model trained by each client device 200.

As such, a series of processes in which the central server 100 transmits parameters to the client device 200 to collect newly learned parameters and then updates the model may be understood as one round of federated learning. A round of federated learning may be performed in a plurality of rounds according to design, and parameters of the global model updated after the final round is performed may be determined as parameters of the final federated learning model.

In this case, the central server 100 may select some of the client devices 200 among the plurality of client devices 200 and transmit the parameters for each round of federated learning according to a predetermined method (e.g., FedAvg, FedSGD, FedMA, etc.).

In this case, the central server 100 may update the parameters of the global model by combining the parameters collected from the client device 200 according to the predetermined method (e.g., FedAvg, FedSGD, FedMA, etc.).

On the other hand, if the number, type, distribution, etc. of the data held by each client device 200 are different from each other in the federated learning, a catastrophic forgetting problem may occur, and if the federated learning model is applied to the individual client device 200 using a data set of a specific distribution, there are cases in which insufficient performance is shown. In order to solve this problem, the federated learning system 10 according to the embodiment of this document provides a method of learning by dividing the parameters to be used by each client device 200 in common and the parameters to be used individually, among the parameters of the federated learning model.

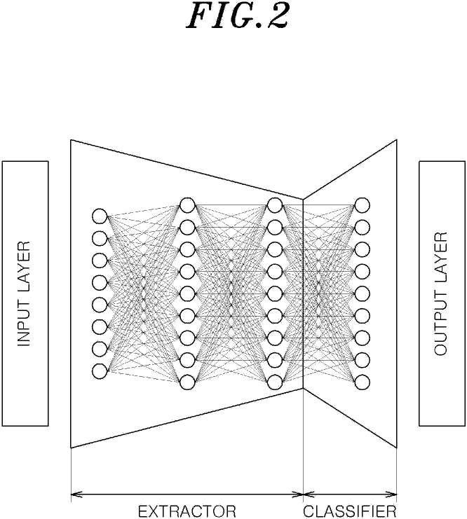

FIG. 2 is an exemplary diagram illustrating the structure of the federated learning model used in the federated learning system 10 according to the embodiment of the present disclosure.

Referring to FIG. 2, the federated learning model according to the embodiment may include a neural network including an input layer, a hidden layer, and an output layer. The federated learning system 10 according to the embodiment divides the hidden layer of the federated learning model into an extractor and a classifier once more.

The extractor may include layers from the frontmost layer in contact with the input layer to a layer just before a layer of the layer of the last end of the hidden layer, among the layers constituting the federated learning model. For example, the extractor may include a network layer including a parameter for performing a convolution calculation by applying a weight and a bias to a predetermined feature value or a feature vector. Hereinafter, the parameter learned by the extractor is collectively referred to as a ‘first parameter’.

The classifier may include the last layer in contact with the output layer among the layers constituting the federated learning model. For example, the classifier may include a network layer including a parameter for classifying a decision boundary for classifying a class for an output layer. Hereinafter, the parameter learned by the classifier is collectively referred to as a ‘second parameter’.

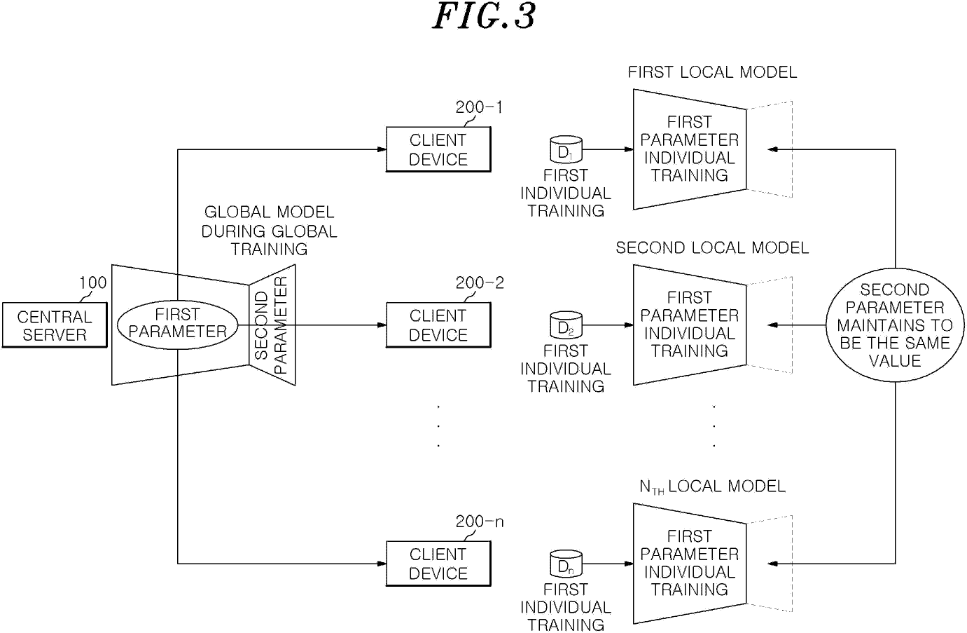

FIG. 3 is an exemplary diagram illustrating an operation in which the central server 100 transmits a first parameter to each client device 200 and each client device 200 trains the first parameter according to the embodiment of the present disclosure.

The central server 100 may transmit the first parameter set in the global model to each client device 200. At this time, the central server 100 may select some of the client devices 200 among all the client devices 200, transmit and update the parameters for each round of federated learning according to a predetermined method (e.g., FedAvg, FedSGD, FedMA, etc.).

Each of the client devices 200-1, 200-2, ..., 200-n may set the first parameter value transmitted by the central server 100 to the extractor of the local model stored respectively as the initial value of training, and may individually train the first parameter using a predefined training algorithm (e.g., CNN, RNN, MLP, etc.) using the individually held data D1, D2, D3. At this time, each client device 200-1, 200-2, ..., 200-n may learn only the first parameter by maintaining the second parameter set in the classifier of the local model to be the same value without updating.

As an example, the central server 100 and all the client devices 200 may be set to have the same second parameter in the federated learning model they store, and it may be defined so that the value is not updated and the same value is maintained.

For example, the value of the second parameter may be defined to have a preset value according to a predetermined weight initialization algorithm (e.g., orthogonal initialization). For example, it may be defined that the central server 100 determines the value of the second parameter to be applied to the classifier according to the weight initialization algorithm, propagates the value of the second parameter to all client devices 200 before the round of federated learning begins, and maintain the value of the second parameter without change during the training process of the first parameter.

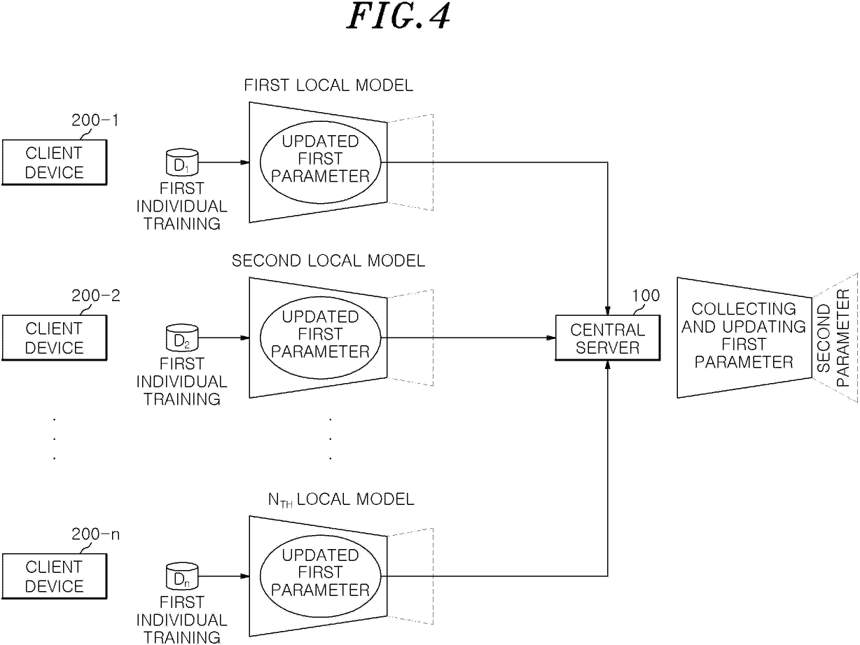

FIG. 4 is an exemplary diagram illustrating an operation of transmitting the first parameter updated by each client device 200 to the central server 100, and updating by the central server 100 the first parameter of the federated learning model by collecting each first parameter according to the embodiment of the present disclosure.

Referring to FIG. 4, each client device 200 may generate a newly trained value of the first parameter using individual data D1, D2, and D3 possessed by each client device. Each client device 200 may transmit the updated value of the first parameter to the central server 100. In this case, the central server 100 may update the value of the first parameter of the global model by combining the value of the first parameter collected from the client device 200 according to the predetermined method (e.g., FedAvg, FedSGD, FedMA, etc.).

According to the embodiment of this document, the processes of FIGS. 3 and 4 described above may be understood as one of the rounds of training rounds of the global model in which the central server 100 and the client device 200 participate together. In the global model training rounds of FIGS. 3 and 4, a preset number of rounds may be performed according to a designer’s selection.

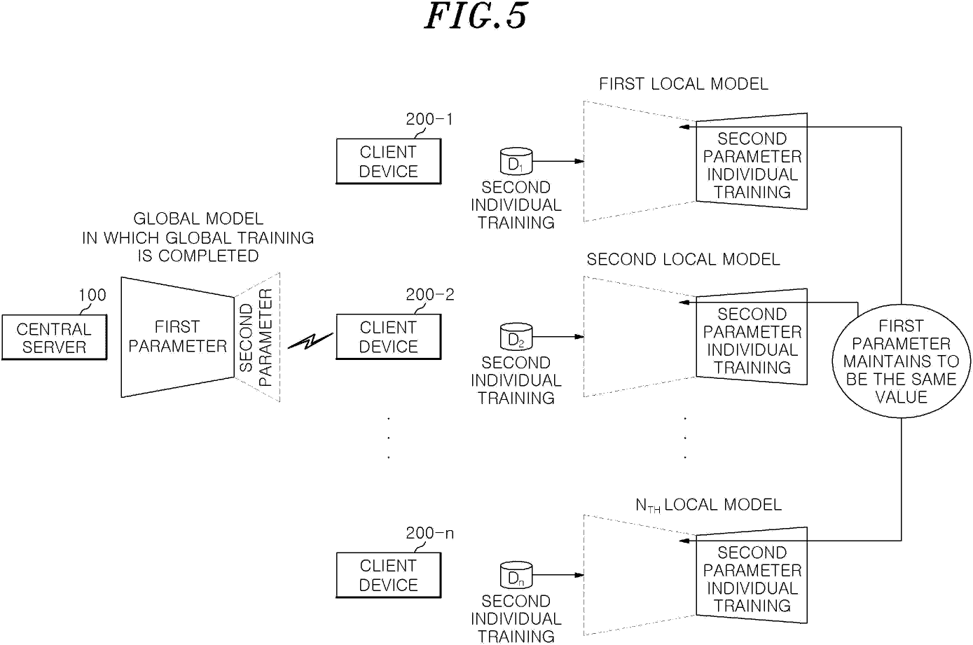

FIG. 5 is an exemplary diagram illustrating an operation of transmitting, by the central server 10, a federated learning model on which training is completed to each client device 200, and training, by each client device 200, a second parameter of the federated learning model according to the embodiment of the present disclosure.

Referring to FIG. 5, the central server 100 may transmit a federated learning model (e.g., a final first parameter value) on which global learning has been completed according to the processes of FIGS. 3 and 4 to each client device 200.

Each of the client devices 200-1, 200-2, ..., 200-n may set the final value of the first parameter transmitted by the central server 100 to the extractor of the stored local model, and may individually train the second parameter using a predefined training algorithm (e.g., CNN, RNN, MLP, etc.) using the data D1, D2, D3 possessed by each client device. At this time, each client device 200-1, 200-2, ..., 200-n may train only the second parameter by controlling the first parameter value set in the classifier of the local model to maintain the same value without being updated.

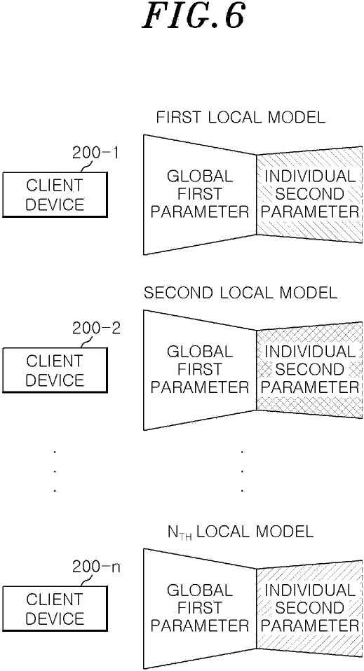

FIG. 6 is an exemplary diagram illustrating a state of a second parameter individualized according to a train data set stored in each client device 200 according to the embodiment of the present disclosure.

Referring to FIG. 6, since each client device 200-1, 200-2, ..., 200-n individually trained the second parameter using stored data D1, D2, and D3, it may have different values of the second parameter. That is, each of the client devices 200-1, 200-2, ..., 200-n may be trained to include a classifier of a decision boundary that is individually customized to be suitable for classifying data mainly used by the user of the client device 200.

As such, in the embodiment of this document, each client device 200 primarily trains the extractor in the federated learning model so that the central server 100 updates the extractor in the federated learning model, and secondarily, each client device 200 individually trains the classifier in the federated learning model according to the train data set stored in each client device 200 when using the federated learning model, thereby it is possible to use the federated learning model customized to the individual data distribution for each client device 200

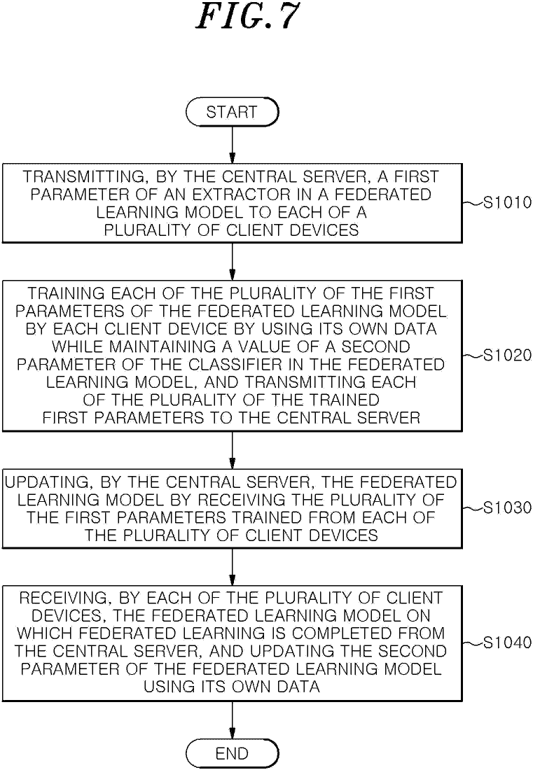

FIG. 7 is a flowchart of the federated learning method according to the embodiment of the present disclosure.

Each step of the federated learning method according to FIG. 7 may be performed by the central server 100 and the client device 200 of the federated learning system 10 described through FIGS. 1 to 6, and each step will be described as follows.

In step S1010, the central server 100 may transmit the first parameter of the extractor of the federated learning model to each client device 200.

In step S1020, each client device 200 may train the first parameter of the federated learning model using its own data while maintaining the second parameter value of the classifier among the federated learning model, and may transmit the trained first parameter to the central server 100.

In step S1030, the central server 100 may receive the first parameter trained from each client device 200 and update the federated learning model.

In step S1040, each of the plurality of client devices 200 may receive the federated learning model on which federated learning has been completed from the central server 100, and may update the second parameter of the federated learning model using the train data set stored in each of the plurality of client devices 200.

On the other hand, in addition to the steps shown in FIG. 7, according to various configurations of embodiments for performing the contents described with FIGS. 1 to 6 described above, a new step of performing an applicable operation in addition to the steps shown in FIG. 7 may be added. Meanwhile, since the configuration of the additional step and the operation for the constituent elements that are the subject of each step to perform the corresponding step have been described with reference to FIGS. 1 to 6, the redundant description will be omitted.

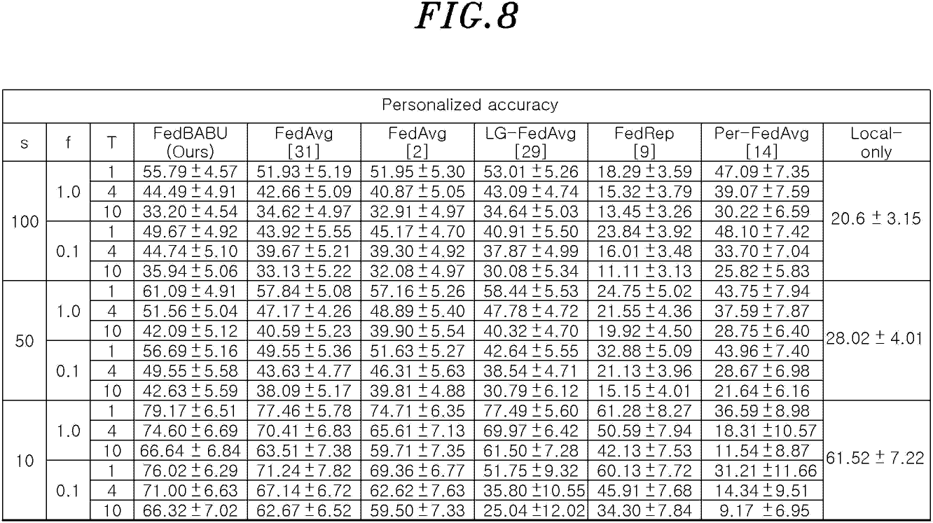

FIG. 8 is a comparison table of accuracies measured by applying the same dataset to a federated learning model (FedBABU) generated by a federated learning system 10 according to the embodiment of the present disclosure and to a federated learning model generated by an existing federated learning algorithm in a plurality of client devices 200.

Referring to FIG. 8, s is a variable for setting the degree of imbalance of data of each client device 200, and f and τ are variables for setting a training environment for federated learning. It can be seen that the accuracy of the embodiment of the present disclosure (FedBABU) in various environments set according to the variables shown in FIG. 8 is significantly improved compared to the accuracy of the federated learning model generated by the existing algorithm.

According to the above-described embodiment, the federated learning model is divided into an extractor and a classifier, and in the primary training process of training the global model, federated learning is performed by intensively training the extractor of the federated learning model from data held by each client device 200, and thus, the federated learning speed can be improved. In addition, in the secondary training process of individually training the local model after the completion of training the global model, each client device 200 uses the data held by each client device 200 to individually train the classifier, so that each client device 200 has a federated learning model having a decision boundary customized by the train data set stored in each client device 200, and accordingly, each client device 200 can use a model with greatly improved accuracy for the data it mainly uses.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present disclosure should be interpreted based on the following claims and it should be appreciated that all technical scopes included within a range equivalent thereto are included in the protection scope of the present disclosure.

What is claimed:

1. A federated learning system comprising:
a central server configured to transmit a first parameter of an extractor in a federated learning model including the extractor and a classifier to each of a plurality of client devices, and receive a plurality of first parameters learned from the plurality of client devices to update the federated learning model; and
the plurality of client devices configured to train each of the plurality of the first parameters of the federated learning model using a training data set stored in each of the plurality of client devices while maintaining a value of a second parameter value of the classifier in the federated learning model, and to transmit each of the plurality of the trained first parameters to the central server.

2. The system of claim 1, wherein each of the plurality of client devices update the second parameter of the federated learning model using the training data set stored in each of the plurality of client devices after each of the plurality of client devices receive the federated learning model on which federated learning is completed from the central server,.

3. The system of claim 1, wherein the second parameter maintains a preset value according to a predetermined weight initialization algorithm in the training process of each of the plurality of the first parameters of each of the plurality of client devices.

4. The system of claim 3, wherein the second parameter maintains a preset value according to an orthogonal initialization algorithm in the training process of each of the plurality of the first parameters of each of the plurality of client devices.

5. The system of claim 1, wherein the classifier includes a layer of the last end in contact with an output layer among layers included in the federated learning model, and
the extractor includes at least one of layers from the frontmost layer in contact with an input layer to a layer just before the layer of the last end among the layers included in the federated learning model.

6. A federated learning method performed by a central server and a plurality of client devices, the method comprising:
transmitting, by the central server, a first parameter of an extractor in a federated learning model including the extractor and a classifier to each of a plurality of client devices;
training, by the plurality of client devices, each of the plurality of the first parameters of the federated learning model by each of the plurality of client devices by using a training data set stored in each of the plurality of client devices while maintaining a value of a second parameter of the classifier in the federated learning model,
transmitting, by the plurality of client devices, each of the plurality of the trained first parameters to the central server; and
updating, by the central server, the federated learning model by receiving the plurality of the first parameters trained from each of the plurality of client devices.

7. The method of claim 6, further comprising:
after the updating of the federated learning model, by each of the plurality of client devices, receiving the federated learning model on which federated learning is completed from the central server, and updating the second parameter of the federated learning model using the training data set stored in each of the plurality of client devices.

8. The method of claim 6, wherein the transmitting of each of the plurality of the trained first parameters to the central server comprises controlling a preset value to be maintained in the second parameter according to a predetermined weight initialization algorithm in the training process of each of the plurality of the first parameters.

9. The method of claim 8, wherein the transmitting of the learned first parameter to the central server comprises controlling a preset value to be maintained in the second parameter according to an orthogonal initialization algorithm in the training process of each of the plurality of the first parameters.

10. The method of claim 6, wherein the classifier includes a layer of the last end in contact with an output layer among layers included in the federated learning model, and
the extractor includes at least one of layers from the frontmost layer in contact with an input layer to a layer just before the layer of the last end among the layers included in the federated learning model.

11. A client device for training a federated learning model, the client device comprising:
a communication unit that transmits and receives information to and from a central server;
a memory; and
a processor,
wherein the processor is configured to:
receive a first parameter of an extractor from the central server that manages the federated learning model including the extractor and a classifier;
train the first parameter of the federated learning model using a training data set stored in the client device, while maintaining a value of a second parameter of the classifier in the federated learning model; and
transmit the trained first parameter to the central server to update the federated learning model managed by the central server.

12. The client device of claim 11, wherein processor updates the second parameter of the federated learning model using the training data set stored in the client device after receiving the federated learning model on which federated learning is completed from the central server.

13. The client device of claim 11, wherein the second parameter maintains to be a preset value according to a predetermined weight initialization algorithm in the training process of the first parameter.

14. The client device of claim 13, wherein the second parameter maintains to be a preset value according to an orthogonal initialization algorithm in the training process of the first parameter.

15. The client device of claim 11, wherein the classifier includes a layer of the last end in contact with an output layer among layers included in the federated learning model, and
the extractor includes at least one of layers from the frontmost layer in contact with an input layer to a layer just before the layer of the last end among the layers included in the federated learning model.
